(19) United States
(12) Patent Application Publication
(10) Pub. No.: US 2026/0240147 A1
(43) Pub. Date: Aug. 20, 2026

(54) MANCOZEB NANOSUSPENSION AND PREPARATION METHOD THEREOF

(71) Applicant: Ziyong Zhang, Nanjing (CN)

(72) Inventors: Ziyong Zhang, Nanjing (CN); Bing Liang, Nanjing (CN)

(21) Appl. No.: 19/139,367

(22) PCT Filed: Dec. 18, 2023
(86) PCT No.: PCT/CN2023/139323

§ 371 Date: Jun. 16, 2025

(30) Foreign Application Priority Data
Dec. 18, 2022 (WO) PCT/CN2022/139831

(51) Int. Cl. A01N 25/04; A01N 47/14

(52) U.S. Cl. CPC A01N 25/04; A01N 47/14

(57) ABSTRACT

The present invention relates to a mancozeb nanosuspension having a particle size less than 100 nanometers and a preparation method thereof. The mancozeb nano-suspension having a particle size less than 100 nanometers is formed by diluting and mixing two or three components with water. The preparation method is: under a condition that the stirring speed is not less than an effective stirring speed, adding a component one dilution to a component two dilution, or adding the component two dilution to the component one dilution to form the mancozeb nano-suspension.

### TECHNICAL FIELD

The present invention belongs to the field of nanopesticides, specifically related to the preparation of nanosuspensions with particle sizes smaller than 100 nanometers (nm).

### BACKGROUND ART

Improving pesticide efficacy is an essential method for reducing pesticide use, and developing nanopesticides represents the optimal approach. Nanopesticides emerged in the early 21st century, employing nanotechnology to decrease particle size in pesticide formulations and achieve nanoscale dispersion. A nanometer (nm) is a length unit, defined as one-billionth of a meter or one-millionth of a millimeter. Briefly, nanopesticides refer to pesticide formulations whose particle sizes are at the nanoscale during application. For effectiveness and stability, particle sizes ideally should be less than 100 nm—the smaller, the better. Currently, traditional pesticide formulations have particle sizes larger than micrometers (μm). If particle sizes are reduced to the nanoscale, theoretically, the number of particles can increase by up to 1 billion times, and the surface area can increase by 1,000 times. This illustrates the rationale behind developing nanopesticides.

In April 2019, on the occasion of its 100th anniversary, the International Union of Pure and Applied Chemistry (IUPAC) listed “nanopesticides” as one of the top ten chemical innovations set to change the future. This recognition arises from nanopesticides' superior target delivery efficiency and improved absorption, addressing significant problems associated with traditional pesticide formulations such as environmental pollution, bioaccumulation in organisms, and rapidly increasing pest resistance. Consequently, nanopesticides significantly reduce pesticide usage and are considered a key technological advancement for next-generation pesticide formulations.

Mancozeb has been used internationally for over fifty years, characterized by large-scale usage, and is an effective protective organic sulfur fungicide. It has features such as low toxicity, prolonged effectiveness, multi-pathogen targeting, low resistance development, and high efficacy, thus gaining widespread popularity in agricultural protection. The development of dithiocarbamate fungicides has undergone a lengthy process. Fungicidal activity of dithiocarbamates was initially discovered by Hester W F. In 1943, Rohm & Haas Company first synthesized Zineb (zinc ethylenebis dithiocarbamate). In 1950, Rohm & Haas and DuPont jointly produced Maneb, enriching the variety of dithiocarbamate fungicides. Ammonium dithiocarbamate and zinc dithiocarbamate have been produced and used extensively domestically, whereas mancozeb was discovered later, demonstrating significant efficacy against various diseases affecting fruits, vegetables, and cereals, with low toxicity and high safety.

Mancozeb has become an important dithiocarbamate fungicide. Chemically, it is defined as manganese ethylene bis(dithiocarbamate) polymeric complex with zinc salt coordination compound. The cyclic chemical structure is represented in structure (1), although some argue it has a linear structure. According to ISO definitions, mancozeb is considered a mixture of zinc and manganese dithiocarbamate salts, containing approximately 20% manganese and 2.55% zinc. The technical-grade product is a greyish-yellow powder, decomposing between 192-204° C. It has extremely low solubility in water (6.2 mg/L at pH 7.5, 25° C.) and is insoluble in most organic solvents. Such low solubility limits its formulation type development and application. It remains stable under normal, dry conditions but decomposes when exposed to heat or humidity.

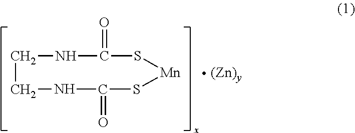

The primary fungicidal mechanism of dithiocarbamates involves reaction with thiol groups in amino acids and enzymes of fungal cells, leading to enzyme inactivation, thus interfering with lipid metabolism, respiration, and ATP production. Mancozeb belongs to broad-spectrum, non-systemic fungicides with protective effects. It is utilized on fruit trees, vegetables, ornamental plants, tobacco, and many other crops. It effectively controls numerous leaf fungal diseases, including early and late blight in potatoes and tomatoes; downy mildew and black rot in grapes; net blotch, stripe disease, and leaf spot diseases in wheat and corn; damping-off and leaf spot diseases in cotton and peanuts; and downy mildew, anthracnose, and blight in vegetables.

Mancozeb can be formulated with various pesticides to create multiple mixed formulations. However, whether used alone or in combination, its physical properties-being insoluble in both water and organic solvents-dictate its main formulations as traditional powders, wettable powders, water-dispersible granules, and suspensions. According to existing pesticide formulation processing technology, the smallest particle sizes typically exceed several micrometers, often tens of micrometers. Large particle sizes of mancozeb limit efficacy, compounded by historical high-volume usage resulting in certain levels of resistance. Thus, the current application dosage remains high, typically between 750 g and 2250 g active ingredient per hectare. Enhancing efficacy and reducing application dosage per area thus becomes essential.

It should be noted that the preparation of current mancozeb pesticide formulations involves synthesizing the technical active ingredient initially, followed by processing into various formulations. Specifically, the steps include: (1) synthesis of the active ingredient, divided into two stages-first synthesizing ammonium or sodium mancozeb, then producing mancozeb through salt formation and coordination reactions with manganese and zinc salts, resulting in blocky precipitates. These precipitates are insoluble in water and organic solvents, requiring separation, washing, and drying to obtain technical-grade mancozeb; (2) formulation processing, where solid technical mancozeb undergoes milling, grinding, and mixing to produce formulated products. This process involves extensive equipment and facilities such as filtration units, drying machines, mills, grinders, mixers, and associated processing procedures. Clearly, from synthesizing soluble ammonium or sodium mancozeb to processing various formulations, the process is both lengthy and energy-intensive.

The conventional production and formulation processes for technical-grade mancozeb and the most common powder and wettable powder formulations are shown in FIG. 1.

### SUMMARY OF THE INVENTION

Prior Application: PCT/CN2022/139831

One of the objectives of the present invention is to overcome the shortcomings of existing technologies and provide a new concept and method for preparing mancozeb powder formulations. Through a water dilution process, ammonium mancozeb (or sodium/potassium mancozeb) reacts with manganese salts and zinc salts to generate mancozeb, resulting in a visually water-soluble and transparent mancozeb nanosuspension directly suitable for spraying.

The mancozeb nanosuspension described in the invention can be loaded into pesticide spraying equipment for direct application.

Ammonium mancozeb is a water-soluble ammonium salt that exists as dispersed single molecules in water, forming one component. The manganese and zinc salts that react with it are also dispersed as single molecules or metal ions in water, forming the other component. When these two meet, mancozeb readily forms through a coordination structure beyond conventional salt formation. This salt formation and coordination reaction proceeds rapidly, and by controlling the addition rate of one component during mixing, nanocrystals of mancozeb can be formed.

Under controlled stirring speeds, an aqueous solution of one component (e.g., manganese or zinc salt) is added to the aqueous solution of the other component (e.g., ammonium mancozeb). By regulating the dropwise addition rate and stirring speed, mancozeb nanocrystals are generated, forming a mancozeb nanosuspension.

These mancozeb nanocrystals, when small in size and few in number, can temporarily remain stable in water. As nanoparticles continue to form, collisions and growth lead to agglomeration. When the size of the mancozeb nanocrystals approaches or exceeds the wavelength of visible light, the suspension begins to exhibit opalescence and gradually turns opaque. Coupled with the influence of gravitational settling of large crystals, precipitation may occur. To prevent this, high molecular weight polymeric additives must be introduced.

These additives are water-soluble polymers, typically amorphous, and when dissolved in water, form randomly coiled chain structures known as random coils. These are loosely spherical structures formed by hydrophobic main chains aggregating inside and hydrophilic polar groups exposed on the outside.

When mancozeb nanocrystals of less than 100 nm are formed, mechanical stirring provides shearing forces that help the water-insoluble particles disperse into and be encapsulated by the random coils. This prevents further collisions, crystal growth, and precipitation. Therefore, the random coils formed by polymeric additives serve to disperse, suspend, stabilize, and protect the mancozeb nanoparticles. As the coils are evenly distributed in the aqueous phase, so are the nanoparticles within them, resulting in a visually clear and transparent suspension—an apparently water-soluble system—due to the absence of strong light scattering or reflection.

It should be noted that during nanoparticle generation, both the dropwise addition speed of the precursor solution and the stirring speed of the aqueous additive solution influence how much is introduced per unit time and how uniformly it is dispersed. These are key factors determining nanoparticle size. To achieve particle sizes smaller than 100 nm, the clarity and transparency of the system serves as an effective criterion. The theoretical basis is that when particle size is less than one-quarter of the minimum visible light wavelength, significant refraction and reflection do not occur, and the system appears transparent. As visible light wavelengths range from 400 to 760 nm, one-quarter of the lower bound is 100 nm. Therefore, if the resulting nanosuspension appears visually transparent, it confirms that the particle size is smaller than 100 nm.

To achieve this goal, attention must be paid to the following points:
\textcircled{1} the mixing speed of the two component solutions (i.e., the addition speed of one component) should not be too fast. Excessive addition speed can cause uneven dispersion and locally high concentrations, leading to rapid crystal formation and a large number of particles. This may result in aggregation between nanoparticles, increasing particle size. If the system begins to exhibit opalescence, it indicates particle sizes have reached several hundred nanometers; worsening opalescence or complete opacity suggests particle sizes have approached or exceeded one micron. Therefore, the addition rate should be controlled to maintain system transparency throughout.
\textcircled{2} the stirring speed of the system should be appropriately increased. Stirring speed affects the rate at which nanoparticles form and disperse in the aqueous phase. Sufficient stirring promotes better dispersion, enabling rapid formation and uniform distribution of smaller particles while preventing aggregation. This facilitates the production of small and evenly sized mancozeb nanocrystals. After completing the addition of both components, continued stirring is necessary for a short time to ensure the nanocrystals are well-dispersed, suspended, and stabilized within the polymeric additive solution.

### Glossary of Terms

Tyndall Effect: The Tyndall Effect refers to the phenomenon where a beam of light passing through a colloid becomes visible from the side, forming a bright “path” through the colloid. This is a form of light scattering caused by particles within the colloid. It occurs because colloidal particles typically range from 1 to 100 nm in size, which is sufficient to scatter visible light. In contrast, true solutions composed of fully dissolved molecules or ions (typically less than 1 nm) scatter light very weakly, so the Tyndall Effect is often used to distinguish colloids from true solutions.

Further explaining the Tyndall Effect: when light encounters particles in a solution, if the particles are significantly larger than the light's wavelength (400-740 nm), strong reflection occurs. If particles are smaller than the wavelength, light is scattered in various directions, creating visible scattered light or opalescence. Because colloidal particles fall between 1-100 nm, they can scatter light strongly enough to create a visible beam. As particle size increases, the system becomes more turbid or opaque, indicating particle sizes in the micron range or above.

System: Refers to the suspension system formed when two components are mixed under controlled addition and stirring conditions to produce a mancozeb nanosuspension. The system consists of water, precursors, zinc salts, manganese salts, and water-soluble polymeric additives.

Component: A combination of one or more ingredients. In theory, each ingredient could constitute a separate component, but for practicality in packaging and use, ingredients are grouped according to two principles: (1) they do not chemically react with one another; and (2) the number of components should be minimized.

Ingredient: The raw materials used in the invention, including water-soluble mancozeb salts, zinc salts, manganese salts, water-soluble polymeric additives, and water.

Precursor: The starting material used to synthesize the target product mancozeb, specifically water-soluble mancozeb salts such as ammonium mancozeb, sodium mancozeb, and potassium mancozeb.

Water-Soluble Polymeric Additive: High molecular weight compounds containing hydrophilic polar groups that dissolve in water. Also called polymeric surfactants or functional agents, they serve to disperse, suspend, emulsify, and stabilize the nanosuspension. Based on their ionic properties, they are categorized into anionic, cationic, amphoteric, and non-ionic types.

Particle Size: Also referred to as particle diameter; it denotes the size of mancozeb nanocrystals formed by interaction between precursors and manganese/zinc salts within the stabilizing medium. It also covers the particle sizes of any other pesticide combinations but does not refer to the internal crystal morphology.

Sub-100 nm Class: A statistical classification of pesticide particle sizes within a suspension system. All particles in the suspension exhibit a distribution of sizes. A suspension is deemed sub-100 nm if the peak value of the particle size distribution curve is less than 100 nm. Measurements can be performed using a Malvern laser nanoparticle size analyser (UK) with data processed using the Number distribution method.

Stability Period: The time during which the nanosuspension remains transparent after preparation. To ensure successful spraying operations, the stability period must be at least 1 hour. An “hour-level stability period” refers to 1-10 hours of stable transparency.

Effective Stirring Speed: The minimum stirring speed at which one component can be added to another without causing excessive particle growth or aggregation. If nanocrystals are dispersed properly and the resulting suspension remains transparent, stirring is considered effective.

Effective Stirring: The method and speed of stirring significantly impact the clarity and stability of the final nanosuspension. Methods include mechanical stirring, multipoint mechanical stirring, manual stirring, or multipoint manual stirring. Sufficient speed enhances dispersion and prevents aggregation. Transparency indicates effective stirring.

Addition Method: Refers to how components A and B are combined-A added to B, B added to A, or both added simultaneously. Other variations include continuous addition, intermittent addition, fine stream addition, drip addition, spray addition, and fixed or moving-point addition. The goal is rapid mixing and dispersion.

Addition Speed: Once an addition method is chosen, the volume added per unit time must be controlled to achieve effective stirring.

Nanoemulsion: Also known as a Nanoemulsion formulation, this is a dispersed system where the pesticide active ingredient forms a solution, which is then emulsified into nanodroplets by surfactants in water. These systems are clear, transparent, have droplet sizes typically below 100 nm, and exhibit thermodynamic stability.

Objective and Application: One of the aims of this invention is to offer a novel method that utilizes water, the typical spraying medium in agricultural applications, to induce in-situ formation of mancozeb nanosuspension through a reaction between ammonium mancozeb (or sodium/potassium analogues) and manganese sulfate and zinc sulfate. The resulting product is a transparent, apparently water-soluble nanosuspension that can be directly sprayed.

Target Crops and Pathogens: The mancozeb nanosuspension can be loaded into spraying equipment and applied directly. It is effective against grapevine diseases (downy mildew, black rot, anthracnose, gray mold), apple and pear diseases (scab, brown rot), stone fruit leaf spots, tomato diseases (wilt, late blight, downy mildew, leaf mold), potato blight, tobacco downy mildew, and rust and leaf spots in vegetables and ornamentals. It is also applicable to citrus, berries, tea plants, and rice. At recommended dosages, the product is safe even for crops at sensitive growth stages.

Formulation Description: The mancozeb nanosuspension defined in this invention refers to suspensions where pesticide particle sizes are under 100 nm, obtained by mixing at least two components with water:

Component A: Water-soluble mancozeb salts or their aqueous solutions, along with a water-soluble polymeric additive; the mancozeb salts may be ammonium, sodium, potassium salts, or mixtures of at least two.

Component B: Manganese and zinc salts in specific mass ratios, or their aqueous solutions.

Component B may also include polymeric additives to enhance solubility.

The preferred water-soluble polymeric additives are non-ionic surfactants.

The ratio of water-soluble polymeric additive to dilution water should not exceed 1:1500; preferably no more than 1:1200; and most preferably, no more than 1:1000. The term “dilution water” includes all water present in the formulation system.

Nonionic Surfactants: These may be selected from water-soluble starch and its derivatives, water-soluble guar gum and its derivatives, polyoxypropylene-polyoxyethylene block copolymers, alkylaryl polyoxypropylene-polyoxyethylene ethers, fatty alcohol polyoxyethylene ethers, fatty acid polyoxyethylene ethers, fatty amine polyoxyethylene ethers, castor oil polyoxyethylene ether, Tween, alkyl glycosides, polyvinyl alcohol, polyvinylpyrrolidone, among others. Preferred surfactants include polyoxypropylene-polyoxyethylene block copolymers, alkylaryl polyoxypropylene-polyoxyethylene ethers, OP-10, fatty alcohol polyoxyethylene ethers, fatty acid polyoxyethylene ethers, castor oil polyoxyethylene ether, Tween, and alkyl glycosides.

Manganese and Zinc Salts: The manganese salt is selected from at least one of the following: manganese sulfate, manganese acetate, manganese chloride, and manganese nitrate. The zinc salt is selected from at least one of the following: zinc sulfate, zinc acetate, zinc chloride, and zinc nitrate.

### Stability and Preferred Ratios

The sub-100 nm mancozeb nanosuspension described in this invention possesses an hour-level stability period.

When the mancozeb salt, manganese salt, and zinc salt are ammonium mancozeb, manganese sulfate, and zinc sulfate respectively, their mass ratio may range as follows:

Ammonium mancozeb (to produce 100 parts of mancozeb): manganese sulfate:

$$zinc sulfate = 90 : 41 - 55 : 7 - 17$$

$$Preferably : 90 : 41 - 43 : 7 - 9$$

$$More preferably : 90 : 41 : 7$$

When the ratio is 90:41:7, the polymeric additive used in component B (in which manganese and zinc salts are dissolved with as little water as possible) should be added in an amount that prevents turbidity-generally not exceeding 5% by mass.

### Sub-100 nm Mancozeb Nanosuspension

To enhance the bio efficacy of nanoscale mancozeb, this invention seeks to minimize particle size as much as possible. The core aim of developing nanopesticides is to increase pesticide effectiveness while reducing the amount used. Traditional pesticide formulations typically have particle sizes in the micrometer range. Reducing this to the nanoscale spans three orders of magnitude, with the number of particles increasing differently depending on how much the size is reduced. For example, reducing typical particle size from 2 μm to 200 nm, 20 nm, and 2 nm would theoretically increase the number of particles by 1,000 (10³), 1 million (10⁶), and 1 billion (10⁹) times, respectively. Clearly, different levels of size reduction lead to significantly different increases in particle count, which in turn impacts pesticidal efficacy. Therefore, minimizing particle size is essential to enhancing nanopesticide performance.

To further improve the efficacy of nanoscale mancozeb, this invention aims to reduce particle size below 100 nm. This is justified on two grounds. First, a size below 100 nm defines the minimum threshold for classifying a material as nanostructured in any one dimension. Second, pesticide particles in the 1-100 nm range form colloidal solutions that appear optically clear and transparent. When illuminated, the solution shows a sharply defined light path—consistent with the Tyndall effect.

### Suspension Concentration

For low-concentration suspensions, the proportion of sub-100 nm particles is higher, and transparency is relatively unaffected. For example, if applying 1,500 g/ha of mancozeb and diluting with more than 50 kg of water, the suspension maintains good clarity.

In high-concentration suspensions, the proportion of sub-100 nm particles is lower, which negatively affects transparency. For instance, using only 20 kg of water to dilute 1,500 g/ha of mancozeb may still yield temporary transparency, but due to high particle concentration, collisions among particles can lead to crystal growth and aggregation, thereby reducing stability and clarity.

Diluting with 20-50 kg of water represents a transitional concentration zone for the nanosuspension.

### Stability Period

The mancozeb nanosuspension prepared according to the present invention is a colloidal solution that appears transparent and apparently water-soluble, but it is not inherently a thermodynamically stable system. Therefore, the duration during which some nanoscale mancozeb suspensions maintain their transparent appearance is not indefinite, and there exists a defined stability period. From the perspective of spray application operations, the suspension should remain stable for at least one-hour post-preparation, making it practical to describe the stability period in terms of hours.

Thus, this invention introduces the concept of a “stability period” for sub-100 nm nanoscale mancozeb suspensions. That is, the suspension should maintain transparency long enough to complete spraying tasks—at least one hour.

From an application standpoint, the stability period can be categorized into four-time ranges: less than 1 hour, 1-5 hours, 5-10 hours, and more than 10 hours.

If the spraying operation is completed within 1 hour and the nanosuspension remains transparent, it indicates the particle size remains under 100 nm.

Visual observation can be used to monitor the transparency of the suspension and changes in particle size. During the stability period, the suspension remains clear, indicating particle sizes under 100 nm. As the suspension becomes unstable, it begins to exhibit opalescence, signaling particle growth. Mild opalescence suggests particles have exceeded 100 nm; increasing opalescence indicates growth to several hundred nanometers; turbidity or loss of transparency implies sizes approaching or exceeding the micrometer range. If crystallization or sedimentation occurs, particle sizes have likely reached the millimeter scale.

The observed stability period phenomena of sub-100 nm mancozeb nanosuspensions described in this invention apply to all hour-level stability durations.

### Hour-Level Stability Period

From the perspective of spray application:

A stability period of approximately 1 hour provides limited operational time. On the other hand, a stability period exceeding 10 hours reduces the practical value of the formulation, as pesticide sprays with low active content and large volume are not ideal for storage or transport-even if highly stable.

Therefore, a stability period of 1 to 10 hours is generally suitable for most agricultural spraying equipment to complete operations efficiently.

The term “hour-level stability period” as used in this invention refers specifically to a period ranging from 1 to 10 hours.

This period can be further subdivided:
1-5 hours: Basic Operational Window-Adequate for completing spraying tasks under most conditions.
5-10 hours: Extended Operational Window-Sufficient to accommodate delays or special situations during spraying.

### Components and Additives of Mancozeb Nanosuspension

Traditional mancozeb formulations, whether single-agent or binary mixtures, are typically one-component systems that can be directly diluted with water for spraying. However, most pesticide particles in these formulations are larger than the micrometer scale. To produce a nanoscale mancozeb suspension, the present invention adopts a system of at least two components. When diluted with water following a specific method, a sub-100 nm mancozeb nanosuspension can be achieved.

### Three-Component Basic Scheme

As an example, the invention describes a basic scheme using three components to produce a sub-100 nm mancozeb nanosuspension:

Component A: Comprised of solid ammonium mancozeb, sodium mancozeb, or potassium mancozeb, or their aqueous solutions. These are the precursors for generating mancozeb nanocrystals. The salts may be used individually or in combination, in either solid or solution form. Solids are convenient for packaging and have smaller volumes; they can be dissolved in water prior to use. Alternatively, aqueous solutions may be diluted directly to a desired concentration before application.

Component B: Composed of manganese and zinc salts in a specific mass ratio, either as solids or aqueous solutions. These provide the multivalent metal ions necessary for forming mancozeb nanocrystals. The manganese salt may include one or more of manganese sulfate, manganese acetate, manganese chloride, or manganese nitrate. The zinc salt may include one or more of zinc sulfate, zinc acetate, zinc chloride, or zinc nitrate. Component B may be solid (for easier packaging) or in aqueous form (requiring defined container specifications due to solubility limits).

Component C: Composed of at least one surfactant or its aqueous solution, serving as an additive to disperse, suspend, and stabilize the resulting mancozeb nanocrystals. These are water-soluble surfactants, either polymeric or small-molecule types. Since polymeric surfactants offer superior dispersion and stability, they are preferred.

The preferred ratio of water-soluble surfactant to dilution water is not more than 1:1000.

Common anionic surfactants (e.g., alkali metal or ammonium salts) are prone to precipitation when encountering multivalent metal ions, which leads to loss of water solubility. Therefore, the invention favors nonionic surfactants as polymeric stabilizing agents.

The water-soluble polymeric additives used in this invention are selected from nonionic surfactants such as:
Polyethylene glycol derivatives (e.g., block copolymers of polyethylene oxide and polypropylene oxide);
Fatty alcohol polyoxyethylene ethers;
Fatty acid polyoxyethylene ethers;
Fatty amine polyoxyethylene ethers;
Vegetable oil polyoxyethylene ethers;
Natural product derivatives (e.g., water-soluble starch, cellulose, chitosan derivatives, dextrin, methylcellulose, ethylcellulose);
Polyhydric alcohol derivatives (e.g., Tween, alkyl polyglycosides);
Synthetic polymers (e.g., polyvinyl alcohol, polyvinylpyrrolidone).

The polymeric additive used may consist of one or more of the above nonionic surfactants.

### Improved Two-Component Scheme

To simplify the formulation and improve packaging, storage, transport, and dilution procedures, the three-component system can be reduced to two components:

Component A: Aqueous solution of ammonium mancozeb (or sodium/potassium equivalents), water-soluble polymeric additive, and water. This combines the precursor with the dispersing/stabilizing surfactant.

Component B: Solid mixture of manganese and zinc salts in specific proportions, or their aqueous solution including water-soluble polymeric additive and water. The manganese salt may include one or more of manganese sulfate, acetate, chloride, or nitrate. The zinc salt may include one or more of zinc sulfate, acetate, chloride, or nitrate.

Due to solubility limits of manganese and zinc salts, and to minimize the volume of Component B, water usage must be restricted. The presence of polymeric additives in Component B is also limited by solubility and volume constraints.

The improvement lies in distributing the total quantity of water-soluble polymeric additive between Component A and Component B. Given the constraints of Component B, the proportion of polymeric additive in it must be limited-unless the volume constraint is waived entirely.

### Component Ratios for Mancozeb Formation

The above-described improved two-component scheme includes:

Component A: Solid ammonium mancozeb (or sodium/potassium equivalents), or their aqueous solutions, along with the added surfactant.

Component B: A solid mixture of manganese sulfate (or acetate, chloride, nitrate) and zinc sulfate (or acetate, chloride, nitrate), or their aqueous solutions, optionally including surfactants.

The quantity of active ingredients determines the formulation design. Component A, containing ammonium mancozeb (or its sodium/potassium counterparts), serves as the precursor and establishes the basis for determining the composition of Component B.

For example, assuming 100 g of mancozeb nanosuspension is needed to spray 1/15 hectare of land, the two-component system is designed based on generating 100 g of sub-100 nm mancozeb nanosuspension.

Component A: Requires about 90 g of ammonium mancozeb as the precursor. According to the previously defined principles of surfactant distribution, the majority of the additive is assigned to Component A. Assuming both components are packaged in 500 g units, the remaining content would be made up by water.

Component B: The required amount of inorganic manganese and zinc salts is determined based on their reaction with ammonium mancozeb. The preferred salts are manganese sulfate and zinc sulfate. Generally, manganese ions react with ammonium mancozeb to replace the ammonium ion, forming cyclic or linear polymeric structures of mancozeb. Zinc ions also participate in salt formation and tend to coordinate with sulfur atoms on mancozeb, forming a complex.

There is no strict stoichiometric ratio between ammonium mancozeb and the manganese/zinc ions. However, the complexation relationship between the precursor and zinc ions can be approximated as:

$$Precursor mass : zinc ion mass = 97.335 \% : 2.665 \%$$

$$Manganese ion molecules : zinc ion molecules = 9 : 1$$

Under this invention, with 90 g of ammonium mancozeb (0.346 mol) as the precursor (yielding 100 g of mancozeb), the corresponding molar mass of anhydrous zinc sulfate would be 56.5 g. However, based on the above ratio, the actual quantity of zinc sulfate used is much lower.

For 90 g of ammonium mancozeb:
Zinc sulfate (anhydrous) is used in the range of 3-8 g, preferably 4-7 g.
Manganese sulfate (anhydrous) is used in the range of 25-65 g, preferably 35-55 g.

All values refer to the anhydrous forms of zinc and manganese sulfates.

### Additive Distribution Between Component A and Component B

Component A primarily contains ammonium mancozeb (or sodium/potassium equivalents).

The reason for separating Component A and Component B is that mixing them triggers an immediate reaction. In a two-component system, Component A must contain the additive-otherwise, a separate additive would need to be added as a third component, complicating both packaging and dilution procedures. The inclusion of additives in Component A is feasible because both ammonium mancozeb and the additives are water-soluble and miscible without causing precipitation or instability. However, due to the high concentrations and viscosity of both components, it is necessary to add water to reduce viscosity and facilitate handling. Once sufficient dilution is achieved, the total mass of Component A should be minimized to reduce production, packaging, and transportation costs.

Component B primarily consists of manganese and zinc salts or their aqueous solutions. It can be composed of a solid mixture of the salts to be dissolved before use, or it may already be in solution form. Due to limited solubility, a minimum amount of water is required. Additives in Component B are optional, for two main reasons:
1. Excessive additives in Component B may lead to film formation on the solution surface (due to interactions among manganese/zinc salts, additives, and water), impairing subsequent dilution.
2. If Component A contains a sufficient amount of additive to ensure dispersion and suspension of the resulting mancozeb nanocrystals, additives may be omitted from Component B.

However, if the mancozeb nanosuspension is used in orchards where large tree canopies require high spray volumes (e.g., over 200 kg of water per mu), the additive in Component A alone may not suffice. In this case, a small amount of additive should be included in Component B to ensure that the total additive content in the diluted suspension is sufficient. Importantly, the additive concentration in Component B's solution must remain low enough to preserve transparency and prevent film formation during storage. The concentration should generally not exceed 5%.

Although increasing the mass of either Component A or B could help address the above issues, doing so would also raise production, packaging, and transport costs. Therefore, while ensuring effective formation of mancozeb, careful balancing of component proportions and packaging size is crucial to minimize the amount of additive and water used.

### Water-Soluble Polymeric Additives

1. The mixed, transparent mancozeb liquid obtained by combining the two components is a ready-to-use nanoscale mancozeb suspension. With dispersive water-soluble polymeric additives added, the mancozeb is suspended and dispersed at the nanoscale in the solution. Because particle sizes are under 100 nm, the resulting suspension appears transparent and is apparently water-soluble.
2. These additives play a key role in determining the size of mancozeb nanocrystals formed during mixing and their ability to remain uniformly dispersed and stably suspended.
3. Polymeric additives are also considered polymeric surfactants, typically defined as substances with molecular weights above 10,000 and surface activity. Compared to small-molecule surfactants, polymeric surfactants not only reduce surface tension but also enhance dispersion, suspension, and viscosity. Based on origin, they may be natural or synthetic. They generally contain hydrophobic backbones and hydrophilic groups (e.g., hydroxyl, carboxyl, carboxymethyl, sulfonic acid, sulfate, phosphate, or amine), making them water-soluble. Examples include natural products and their derivatives (e.g., starch, dextrin, water-soluble starches, oxidized starches, modified cellulose, carboxymethyl cellulose, chitosan derivatives, guar gum derivatives, tea saponin, water-soluble humic acid, sodium lignosulfonate) and synthetic polymers (e.g., polyvinyl alcohol, polyacrylic acid, polyacrylamide, polystyrene-maleic anhydride copolymers, polyvinylpyrrolidone). Due to the poor biodegradability of carbon-chain-based synthetic polymers, natural or biodegradable polymers are preferred for environmental reasons.
4. These polymers form disordered coils (also known as micelles) in solution. They dissolve as flexible linear chains that curl into random coils with hydrophilic outer layers and hydrophobic interiors. The size of these coils depends on molecular weight, concentration, and structure. Nanocrystals generated in the system tend to embed within these coils based on similarity in hydrophobicity, leading to enhanced dispersion and stabilization.
5. Depending on functional group type, polymeric additives are categorized into anionic, cationic, amphoteric, and non-ionic types. Anionic types (e.g., carboxymethyl starch, lignosulfonates, polyacrylic acid) contain acidic groups and metal ions. Cationic types (e.g., chitosan hydrochloride, quaternized polymers) contain basic groups. Amphoteric types (e.g., carboxymethyl chitosan, carboxymethyl cellulose) contain both. Non-ionic types include block copolymers like polyoxyethylene-polyoxypropylene-polyoxyethylene, and polyoxyethylene ethers derived from fatty alcohols, acids, amines, alkylphenols, castor oil, and other groups (e.g., Tween, OP series, alkyl polyglycosides).
6. Anionic, cationic, and amphoteric types often react undesirably with metal ions (e.g., sulfate zinc), forming precipitates or interfering with mancozeb formation. Therefore, such types are not suitable as stabilizers in this invention.
7. Only non-ionic polymeric additives are suitable as dispersive stabilizers. Their hydrophilic polyoxyethylene chains form micelles that encapsulate hydrophobic mancozeb nanocrystals, thus stabilizing the suspension.
8. The nanosuspension is formed during pre-application dilution, using water-soluble ammonium mancozeb (or sodium/potassium), manganese salts, and zinc salts. With effective ingredient concentrations around 0.5-1.0 g/kg water (e.g., 100 g per mu in 100-200 kg water), the dispersive stability is tunable by adjusting additive content. For 100 g/mu mancozeb:

$$100 kg water \to 0.1 \% active content$$

$$150 kg water \to 0.067 \%$$

$$200 kg water \to 0.05 \%$$

$$Recommended additive concentration : 0.1 \% - 0.5 \%$$

Tests show nanosuspension particle sizes range from 10-80 nm and remain stable for up to 8 hours, suitable for various spraying equipment.
9. This formulation method allows direct generation of mancozeb nanosuspension upon dilution, avoiding the need for prior synthesis and purification of mancozeb technical material and further processing into wettable powders. This approach reduces energy consumption and environmental burden, cuts production costs, and yields particles smaller than any existing mancozeb formulation, significantly enhancing efficacy and reducing dosage. Field trials on fruit trees confirm the results.

A flow diagram of the dilution-based preparation process is shown in FIG. 2.

### Key Technologies of the Invention

### 1. Formation Process of Nanopesticides

The invention introduces a novel model and method for preparing nanosuspensions of metal-containing pesticides that are insoluble in water and organic solvents. By utilizing the dilution process required for spraying pesticides, the precursor is mixed with metal salts, leveraging rapid metal ion reactions and controlling mixing and stirring rates. This enables the direct formation of sub-100 nm nanosuspensions. This eliminates the need for chemical synthesis and purification of mancozeb technical material at pesticide plants and the multi-step physical processing at formulation plants. This approach is especially suitable for mancozeb and other similar fungicides.

### 2. Concentration of Mancozeb

Controlling the concentration of mancozeb formed from Component A (ammonium/sodium mancozeb) and Component B (zinc and manganese salts) in the diluted solution is key. For example, to apply 100 g mancozeb per mu ( 1/15 hectare), the concentration of precursors should range:

$$Ammonium mancozeb : 0.09 - 0.045 g / kg$$

$$Zinc sulfate : 0. 07 - 0.0035 g / kg$$

$$Water volume : 100 - 200 kg$$

Too little water (<20 kg) results in larger particles and poor transparency due to high particle collision rates. Too much water (>200 kg) dilutes dispersants excessively, compromising stability. Therefore, controlling the dilution water volume is essential.

### 3. Type and Dosage of Dispersants

Choosing appropriate dispersants is another core aspect. Without dispersants, particles undergo Brownian motion and collide, causing aggregation and sedimentation. Polymeric dispersants help prevent this. Their random coil structures (hundreds of nm in size) encapsulate smaller nanocrystals (e.g., <100 nm), inhibiting growth through steric hindrance.

However, not all water-soluble polymers are effective. Experiments showed only nonionic polymeric dispersants such as polyoxyethylene ethers (e.g., OP-10, Tween-80), alkyl polyglycosides, and castor oil derivatives performed well. Anionic types often react with multivalent metal ions like zinc or manganese, forming precipitates and removing the nanocrystals from solution. Cationic and amphoteric types also risk disrupting mancozeb formation. In rare cases, cationic-non-ionic blends may work without precipitation.

The presence of water-soluble polymeric dispersants during the in situ reaction between mancozeb precursors and metal salts is essential to form and stabilize <100 nm particles. Without it, nanocrystals aggregate rapidly and settle. The dispersant dosage must meet two criteria:
The resulting nanosuspension must appear transparent (implying particle sizes <100 nm).
It must remain stable for 1-10 hours, preferably at least 1-5 hours.

In two-component systems, dispersants are divided between Component A and B. If both components are volume-restricted (e.g., 500 g packages), Component B's solubility limitations constrain dispersant inclusion. The formula is:

$$Dispersant\_A = Total dispersant - Dispersant\_B$$

Component B's dispersant upper limit is reached when the solution turns cloudy. Dispersant-to-water ratios should be:

$$\leq 1 : 1200 ( minimum requirement )$$

$$Preferably : \leq 1 : 1000$$

### 4. Addition Method

The addition method also significantly impacts final particle size and stability. For example, if 100 kg of water is used, how it is split between Components A and B, and the direction of mixing (A into B or vice versa), influences reaction dynamics. Critical factors include:
Dispersant concentration in the precursor solution
Instantaneous reactant concentration during mixing
Stirring speed and effectiveness

In general, a higher dispersant concentration in the precursor and effective stirring promote better dispersion and stability of the formed nanocrystals.

### Preparation Method for Mancozeb Nanosuspension

The present invention adopts the following technical scheme:

Under stirring at or above the effective stirring speed, either Component A dilution is added to Component B dilution, or vice versa, to form the mancozeb nanosuspension.

Component A and Component B dilutions are aqueous solutions prepared by diluting the following components:
Component A: A water-soluble mancozeb salt or its aqueous solution, and a water-soluble polymeric additive. The water-soluble mancozeb salt refers to ammonium mancozeb, sodium mancozeb, potassium mancozeb, or mixtures of two or more.
Component B: A defined-ratio solid mixture of manganese and zinc salts, or their aqueous solution.

By controlling the addition method, addition speed, and stirring speed, mancozeb nanocrystals smaller than 100 nanometers are generated, resulting in the desired nanosuspension.

### Effective Stirring Speed

“Effective stirring speed” refers to a stirring condition where, under a specific addition method and rate, nanocrystals formed in the liquid are promptly dispersed. This prevents the significant aggregation of particles, which could lead to sizes of several hundred nanometers or even microns.

### Stirring Methods

Manual stirring: Suitable for most field applications. The speed must align with natural ergonomic limits and should not be too fast.
Mechanical stirring: Though large field tanks with stirring devices are less common, if available, stirring speeds below 100 rpm are generally sufficient.

With manual stirring, speed should match natural human movement. Slower addition speeds may be required to ensure product transparency—an indicator of uniform dispersion.

### Addition Method and Speed

To ensure fine, even dispersion upon entering the system:
Components can be added continuously, intermittently in portions, or dropwise.
Dropwise addition (e.g., using a common agricultural hand sprayer) offers optimal results.
Addition rate should be adjusted according to the observed transparency of the suspension.

In conventional pesticide usage, products are typically diluted with water or co-mixed before spraying—a process known as “tank mixing.” This invention uses the same principle: by mixing Components A and B with appropriate concentrations, methods, and speeds—under the action of specific dispersants—a transparent mancozeb nanosuspension suitable for direct field spraying is obtained through this on-site “tank mixing” process.

### Dilution Water Volume

Current experimental data indicate that a minimum of 20 kilograms of water is a reasonable starting threshold. The dilution volume is closely correlated with the target stability period. Since this is a multivariable problem, other factors—such as the composition and concentration of additives in the components—may also play a role.

The objective of the present invention is to obtain a transparent mancozeb nanosuspension with a particle size below 100 nanometers and a stability period of 1 to 10 hours. When the quantities of precursor (e.g., 90 grams of ammonium mancozeb) and corresponding metal salts (manganese sulfate and zinc sulfate) are fixed, the particle size and stability are influenced by the dilution water volume, additive dosage, and preparation method.

Water volume affects the concentration of the reactants at the moment of mixing and their dispersion uniformity, which in turn influences the size of the formed nanocrystals, their dispersion quality, and the likelihood of aggregation or crystal growth. Similarly, the quantity of dispersant influences its concentration in solution and therefore its ability to stabilize the nanocrystals.

If the water volume is too low (e.g., under 20 kg), the transparent nanosuspension tends to have a short stability time—around 1 hour—insufficient for spraying operations. Therefore, more water is required.

To generate 100 grams of the target nanosuspension (transparent and stable for 1-10 hours, with particle size below 100 nm), the recommended dilution water volume is between 30 and 300 kilograms, preferably in the range of 50 to 200 kilograms.

### BRIEF DESCRIPTION OF THE DRAWINGS

FIG. 1: Process flow of traditional preparation of mancozeb technical material and its conversion into wettable powder formulations.

FIG. 2: Flow diagram illustrating the two-component method for preparing mancozeb nanosuspension.

FIG. 3: Flow diagram illustrating the three-component method for preparing mancozeb nanosuspension.

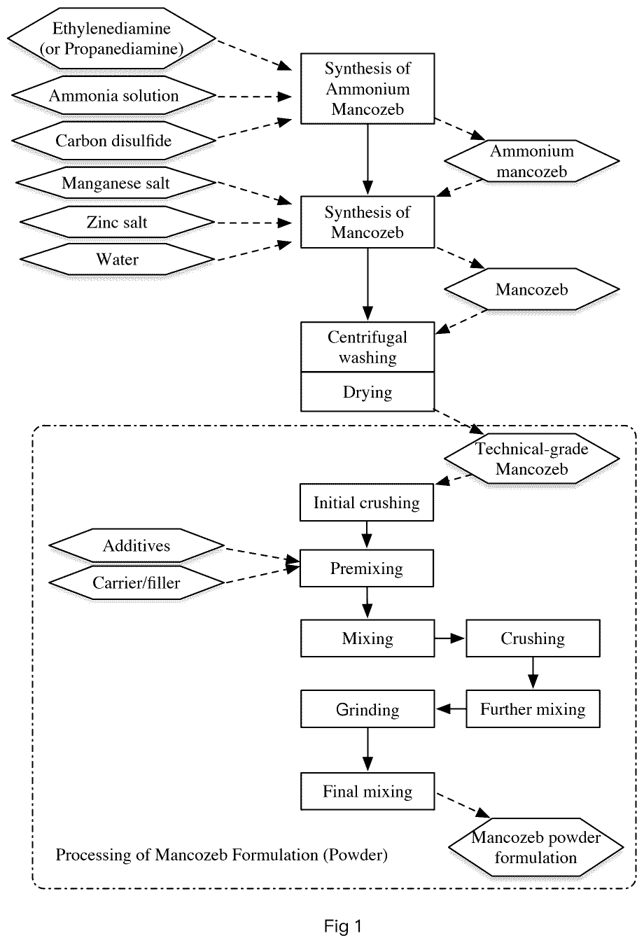

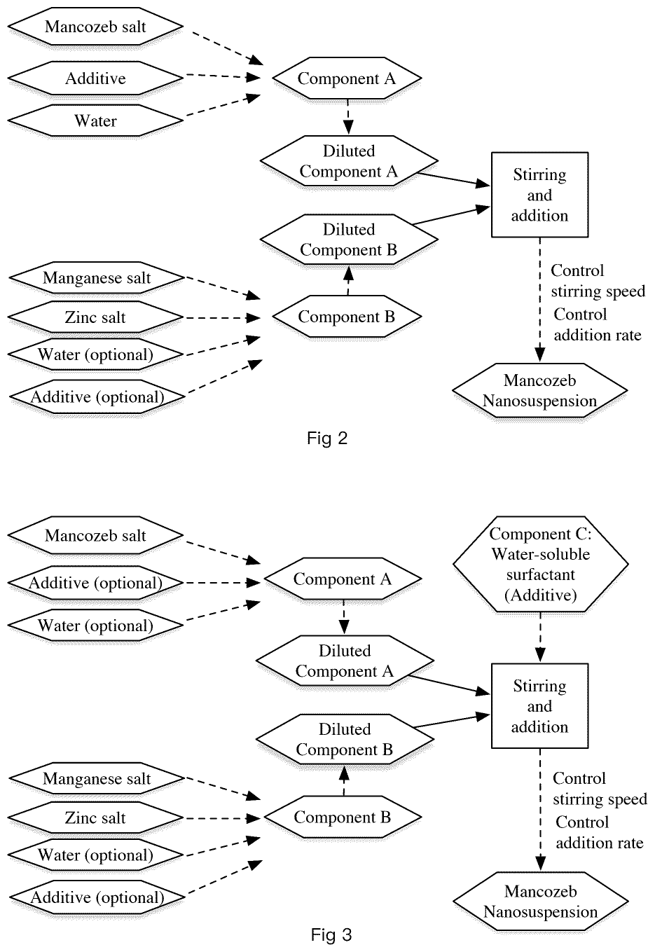

### EMBODIMENTS

The method for preparing a transparent mancozeb nanosuspension with particle size below 100 nm according to the present invention involves the following steps:

### Two-Component Method:

1. Dilute Component A and Component B separately using different water volumes and dilution ratios to form their respective aqueous solutions.
2. Under mechanical stirring (preferred) or manual stirring at a speed not less than the effective stirring speed, add Component A solution into Component B solution (or vice versa) using a chosen addition method (e.g., continuous, intermittent, dropwise, or spray addition) to form the nanosuspension.

### Three-Component Method:

1. Dilute Component A (or Component C) and Component B separately using varying water volumes and dilution ratios to form their respective aqueous solutions.
2. Add Component C (or Component A) to the other component's solution, stir and disperse evenly to form a combined diluted solution of Components A and C.
3. Under mechanical stirring (preferred) or manual stirring at a speed not less than the effective stirring speed, add Component B solution to the combined solution of Components A and C (or in reverse order) using a suitable method (continuous, intermittent, dropwise, or spray addition).

### Embodiment 1

The mancozeb nanosuspension is effective in treating early blight in potatoes. The active ingredient dosage is approximately 100 grams per mu ( 1/15 hectare), with a typical dilution water volume of 30 kilograms. To generate 100 grams of mancozeb, 90 grams of ammonium mancozeb are required.

Component Ratios: The ratio of components, water dilution volume, water distribution, addition order and method, and experimental results are summarized in the following table:

| | | | Dilution | Water | | | |
|---|---|---|---|---|---|---|---|
| | | Total | Water | Distribution | Addition | Addition | |
| Component | Composition (g) | (g) | (kg) | Ratio | Order | Method | Result |
| A | Ammonium mancozeb: 90 | 400 | 30 | 4/5 and 1/5 | Add B | Continuous | Transparent |
| | Additive: 220 | | | | dilution | fine addition | mancozeb |
| | Water: 90 | | | | into A | | nanosuspension; |
| B | Manganese sulfate: 42 | 50 | | | dilution | | precipitation |
| | Zinc sulfate: 8 | | | | | | observed after 3 h |

Additive Used: Alkylaryl polyoxyethylene ether / Tween-80 / OP-10 (mass ratio 50:30:20)

Operating Method: Component A and Component B were separately diluted in water at a 4:5 and 1:5 ratio respectively, based on a total of 30 kg of dilution water. Under stirring, Component B dilution was added into Component A dilution via continuous fine stream addition, resulting in a visually transparent mancozeb nanosuspension. Stability lasted for 3 hours.

### Embodiment 2

The mancozeb nanosuspension is suitable for treating apple tree diseases such as leaf spot, anthracnose, and ring rot. The effective ingredient dosage is 100 grams per mu, with a typical dilution water volume of 200 kilograms. To produce 100 grams of mancozeb, 90 grams of ammonium mancozeb are used.

Component Ratios: The ratios of components, dilution water volume, water distribution, addition sequence and method, and test results are presented in the table below:

| | | | Dilution | Water | | | |
|---|---|---|---|---|---|---|---|
| | | Total | Water | Distribution | Addition | Addition | |
| Component | Composition (g) | (g) | (kg) | Ratio | Order | Method | Result |
| A | Ammonium mancozeb: 90 | 400 | 200 | 2/3 and 1/3 | Add B | Continuous | Transparent |
| | Additive: 220 | | | | dilution | spray | mancozeb |
| | Water: 90 | | | | into A | addition | nanosuspension; |
| B | Manganese sulfate: 42 | 400 | | | dilution | | precipitation |
| | Zinc sulfate: 8 | | | | | | observed after 5 h |
| | Additive: 20 | | | | | | |
| | Water: 330 | | | | | | |

Additive Used: Polyoxypropylene-polyoxyethylene block copolymer / Castor oil polyoxyethylene ether / Tween-80 (mass ratio 50:30:20)

Operating Method: Component A and Component B were separately diluted using 200 kilograms of dilution water in a 2:3 and 1:3 ratio respectively. Under stirring, Component B dilution was continuously sprayed into Component A dilution, producing a visually transparent mancozeb nanosuspension with a stability period of 5 hours.

### Embodiment 3

The mancozeb nanosuspension is effective in controlling pear scab. The active ingredient dosage is 200 grams per mu, and the typical dilution water volume is 300 kilograms. To produce 200 grams of mancozeb, 180 grams of ammonium mancozeb are required.

Component Ratios: The ratios of components, dilution water volume, water distribution, addition sequence and method, and test results are presented in the table below:

| | | | Dilution | Water | | | |
|---|---|---|---|---|---|---|---|
| | | Total | Water | Distribution | Addition | Addition | |
| Component | Composition (g) | (g) | (kg) | Ratio | Order | Method | Result |
| A | Ammonium mancozeb: 180 | 400 | 300 | 4/5 and 1/5 | Add B | Continuous | Transparent |
| | Water: 220 | | | | dilution into | spray | mancozeb |
| B | Manganese sulfate: 84 | 100 | | | mixed | addition | nanosuspension; |
| | Zinc sulfate: 16 | | | | dilution of | | precipitation |
| C | Additive: 400 | 400 | | | Components | | observed after 4 h |
| | | | | | C and A | | |

Additive Used: Castor oil polyoxyethylene ether / Alkylaryl polyoxypropylene-polyoxyethylene ether / Tween-80 (mass ratio 40:20:40)

Operating Method: Component C and Component B were diluted separately using 300 kilograms of dilution water in a 4:5 and 1:5 ratio, respectively, to prepare Component C dilution and Component B dilution. Component A was then added to the Component C dilution and stirred to form a homogenous mixture. Under continuous stirring, Component B dilution was sprayed into the mixture of Component C and A to produce a visually transparent mancozeb nanosuspension with a stability period of 4 hours.

### Embodiment 4

The mancozeb nanosuspension is suitable for controlling tobacco black spot disease. The effective ingredient dosage is approximately 100 grams per mu, with a typical dilution water volume of 25 kilograms. To produce 100 grams of mancozeb, 90 grams of ammonium mancozeb are used.

Component Ratios: The ratios of components, dilution water volume, water distribution, addition sequence and method, and test results are presented in the table below:

| | | | Dilution | Water | | | |
|---|---|---|---|---|---|---|---|
| | | Total | Water | Distribution | Addition | Addition | |
| Component | Composition (g) | (g) | (kg) | Ratio | Order | Method | Result |
| A | Ammonium mancozeb: 90 | 400 | 25 | 4/5 and 1/5 | Add B | Intermittent | Transparent |
| | Additive: 220 | | | | dilution | spray | mancozeb |
| | Water: 90 | | | | into A | addition | nanosuspension; |
| B | Manganese sulfate: 42 | 50 | | | dilution | | precipitation |
| | Zinc sulfate: 8 | | | | | | observed after |
| | | | | | | | 2.5 h |

Additive Used: Castor oil polyoxyethylene ether / OP-10 / Tween-80 (mass ratio 50:30:20)

Operating Method: Component A and Component B were separately diluted using 25 kilograms of dilution water in a 4:5 and 1:5 ratio, respectively. Under stirring, Component B dilution was added into Component A dilution by intermittent spray. A visually transparent mancozeb nanosuspension was obtained, with a stability period of 2.5 hours.

### Embodiment 5

The mancozeb nanosuspension is suitable for treating early blight in tomatoes. The effective ingredient dosage is approximately 70 grams per mu, with a typical dilution water volume of 30 kilograms. To produce 70 grams of mancozeb, 63 grams of ammonium mancozeb are used.

Component Ratios: The ratios of components, dilution water volume, water distribution, addition sequence and method, and test results are presented in the table below:

| | | | Dilution | Water | | | |
|---|---|---|---|---|---|---|---|
| | | Total | Water | Distribution | Addition | Addition | |
| Component | Composition (g) | (g) | (kg) | Ratio | Order | Method | Result |
| A | Ammonium mancozeb: 63 | 400 | 30 | 2/3 and 1/3 | Add B | Continuous | Transparent |
| | Additive: 220 | | | | dilution | dripping | mancozeb |
| | Water: 117 | | | | into A | | nanosuspension; |
| B | Manganese sulfate: 32 | 400 | | | dilution | | precipitation |
| | Zinc sulfate: 6 | | | | | | observed after |
| | Additive: 12 | | | | | | 3.5 h |
| | Water: 350 | | | | | | |

Additive Used: Castor oil polyoxyethylene ether / Alkylaryl polyoxyethylene ether / OP-10 / Tween-80 (mass ratio 40:30:20:10)

Operating Method: Component A and Component B were separately diluted using 30 kilograms of water at a ratio of ⅔ and ⅓, respectively. Under stirring, Component B dilution was continuously dripped into Component A dilution, producing a visually transparent mancozeb nanosuspension. Stability period: 3.5 hours.

1. A mancozeb nanosuspension characterized in that said mancozeb nanosuspension refers to a nanosuspension of mancozeb with particle sizes below 100 nm; said mancozeb nanosuspension below 100 nm is formed by diluting and mixing two components with water:
Component A: water-soluble mancozeb salts or aqueous solutions thereof, and a water-soluble polymeric additive; wherein said water-soluble mancozeb salt is ammonium mancozeb, sodium mancozeb, potassium mancozeb, or mixtures of at least two of these water-soluble mancozeb salts;
Component B: a mixture of manganese and zinc salts, or their aqueous solutions, in specific proportions.

2. The mancozeb nanosuspension according to claim 1, characterized in that said mancozeb nanosuspension below 100 nm has stability lasting for several hours.

3. The mancozeb nanosuspension according to claim 1, characterized in that component B additionally includes a water-soluble polymeric additive and water to form an aqueous solution.

4. The mancozeb nanosuspension according to claim 1, characterized in that said water-soluble polymeric additive is a non-ionic surfactant.

5. The mancozeb nanosuspension according to claim 1, characterized in that the ratio of the amount of water-soluble polymeric additive to dilution water is no greater than 1:1200.

6. The mancozeb nanosuspension according to claim 4, characterized in that said non-ionic surfactant includes at least one of the following:
water-soluble starch and its derivatives, water-soluble guar gum and its derivatives, polyoxypropylene-polyoxyethylene block copolymers, alkylaryl polyoxypropylene polyoxyethylene ethers, fatty alcohol polyoxyethylene ethers, fatty acid polyoxyethylene ethers, fatty amine polyoxyethylene ethers, castor oil polyoxyethylene ether, Tween, alkyl glycosides, polyvinyl alcohol, polyvinylpyrrolidone.

7. The mancozeb nanosuspension according to claim 6, characterized in that the manganese salt is at least one selected from manganese sulfate, manganese acetate, manganese chloride, manganese nitrate; the zinc salt is at least one selected from zinc sulfate, zinc acetate, zinc chloride, zinc nitrate.

8. The mancozeb nanosuspension according to claim 7, characterized in that when the mancozeb salt, manganese salt, and zinc salt are ammonium mancozeb, manganese sulfate, and zinc sulfate, respectively, their mass ratios are:
$$Ammonium mancozeb : manganese sulfate : zinc sulfate = 90 : 41 - 55 : 7 - 17 ;$$
$$Preferably , ammonium mancozeb : manganese sulfate : zinc sulfate = 90 : 41 - 43 : 7 - 9.$$

9. A mancozeb nanosuspension characterized in that it refers to a nanosuspension of mancozeb with particle sizes below 100 nm; this nanosuspension is formed by diluting and mixing three components with water:
Component A: Solid ammonium mancozeb and/or sodium mancozeb and/or potassium mancozeb, or their aqueous solutions;
Component B: A mixture of manganese and zinc salts in specific proportions or their aqueous solutions;
Component C: At least one water-soluble surfactant or its aqueous solution.

10. The mancozeb nanosuspension according to claim 9, characterized in that the ratio of the amount of water-soluble surfactant to dilution water is no greater than 1:1200.

11. The mancozeb nanosuspension according to claim 9, characterized in that the nanosuspension below 100 nm has stability lasting for several hours.

12. The mancozeb nanosuspension according to claim 9, characterized in that component B is composed of inorganic manganese and zinc salts mixed in specific proportions.

13. The mancozeb nanosuspension according to claim 12, characterized in that the manganese salt is at least one selected from manganese sulfate, manganese acetate, manganese chloride, manganese nitrate; the zinc salt is at least one selected from zinc sulfate, zinc acetate, zinc chloride, zinc nitrate.

14. The mancozeb nanosuspension according to claim 9, characterized in that the water-soluble surfactant is a polymeric surfactant and/or a low molecular weight surfactant.

15. The mancozeb nanosuspension according to claim 14, characterized in that the polymeric surfactant is selected from nonionic surfactants.

16. The mancozeb nanosuspension according to claim 15, characterized in that the nonionic surfactant includes at least one of the following:
water-soluble starch and its derivatives, water-soluble guar gum and its derivatives, polyoxypropylene-polyoxyethylene block copolymers, alkylaryl polyoxypropylene polyoxyethylene ethers, fatty alcohol polyoxyethylene ethers, fatty acid polyoxyethylene ethers, fatty amine polyoxyethylene ethers, castor oil polyoxyethylene ether, Tween, alkyl glycosides, polyvinyl alcohol, polyvinylpyrrolidone.

17. A preparation method for the mancozeb nanosuspension as described in claim 1; characterized in that under stirring conditions with a stirring speed not less than the effective stirring speed, a diluted solution of component A is added to a diluted solution of component B, or vice versa, forming the mancozeb nanosuspension.

18. The preparation method according to claim 17, characterized in that the manner of adding one component to another is selected from continuous addition, intermittent addition, dripping addition, and spray addition.
